(19) United States
(12) Patent Application Publication
(10) Pub. No.: US 2003/0020254 A1
(43) Pub. Date: Jan. 30, 2003

(54) Linear stroke drive mechanism

(76) Inventor: William H. Weaver II, Surfside Beach, SC (US)

Correspondence Address: Michael E. Mauney, Attorney at Law, P. O. 10266, Southport, NC, 28461, US

(21) Appl. No.: 09/915,959

(22) Filed: Jul. 26, 2001

(51) Int. Cl. B62M 1/04

(52) U.S. Cl. 280/252

(57) ABSTRACT

A bicycle drive mechanism which allows desynchronized pedaling. Pedals connected to shuttles are mounted in rail guides for generally linear movement. The pedals are elastically connected to each other which allows each pedal to move independently of each other for at least two inches of desynchronized motion. A drive element is mounted around two approximately equally size sprockets. Pushing each pedal either pushes or pulls the drive element around the sprocket. The rotation of the sprockets drives a standard bicycle gear sprocket and chain mechanism to power the rear wheel of a bicycle.

### BACKGROUND OF THE INVENTION

1. Field of the Invention

The present invention relates to a drive mechanism that uses a linear stroke. More specifically, the drive mechanism of this invention uses motion in a generally linear path powered by a user to drive rotary motion for a sprocket. It will find its widest use in bicycles and has other applications as well.

2. Description of Related Art

Bicycles have been known and used for over a century. They are used for exercise, for transportation, and for competition. Because of their widespread use, the conventional bicycle design has undergone many refinements and improvements since its origination over a century ago. Typically, a conventional bicycle incorporates an axle located approximately midway between the front and rear tires. There is at least one drive sprocket connected to the axle, which uses a chain to transmit rotary motion to a sprocket fixed to the rear tire to drive the rear tire of the bicycle. Perpendicularly mounted to the axle are shafts, which have pedals at the end of the shafts. The user places his or her feet on each pedal and uses the legs to force a pedal downwardly. The pedals move in a rotational motion in response to the force of the user around the axle and rotates the drive sprocket to provide propulsive force to the rear tire. A variety of expedients are employed to increase the efficiency of the force applied by the user, including multiple sprockets, clutch mechanisms, gear change mechanisms, and so on.

Despite this work, the drive mechanism of a conventional bicycle is inefficient If one envisions the pedal path as a clock face, one will see that the pedal moves completely around the clock. However, when the oppositely placed pedals are at respectively the twelve o'clock and six o'clock position, the natural downward push of a user's legs will do nothing to propel the bicycle forward. As any rider knows, it can be difficult to start a bicycle from a stopped position with the pedals at the twelve and six o'clock position. Ordinarily, an experienced user will position the pedals to where they are at approximately the three o'clock and nine o'clock positions, place a foot on the pedals at the three o'clock position (from the right side), then mount the bicycle. As one's weight is transferred to the pedal, this forces the pedal downwardly and begins the forward motion of the bicycle. The momentum developed by the mounting motion allows the user to begin to pedal the bicycle applying appropriate force on each pedal at approximately the one o'clock to five o'clock positions. The maximum efficiency is developed when the vector of the force exerted by a user is on the line intersecting with the circle of motion of the pedals. Ideally one would like to be able to develop a drive mechanism that would allow one to exert a force along this vector of maximum efficiency. That is to say, ideally the user's leg motions should be in a straight line back and forth motion, not unlike the kind of motion employed on a stair climber exercise machine. Thus, it has been recognized that allowing a user of a bicycle to employ force in a rectilinear motion along the line best suited to the position of the user while seated on the bicycle is inherently more efficient than the traditional pedal, shaft, and axle circular motion used in a conventional bicycle.

As early as 1900 in the A. M. Allen, U.S. Pat. No. 661,630, it was recognized that a straight line pedal motion is more desirable than the rotating pedal motion of a conventional bicycle. A number of other inventors have also employed mechanisms to allow a user to employ a straight line stroke as opposed to a rotary stroke. Zampedro, U.S. Pat. No. 4,169,609, employed pedals mounted in carriages. Reciprocating motion of the pedals imparts a rotary motion to drive the bicycle. Each pedal drives a chain encircling sprockets. These sprockets drive the drive sprocket. The pedals are connected to each other by a wire over a pulley, so that when one pedal is moving the other pedal is compelled to move in the opposite direction. Meguerditchian, U.S. Pat No. 5,236,211, likewise employs pedals mounted on a guide. The pedals are connected by a flexible wire running over pulleys. The pulleys drive a common axle, which drives a sprocket, which is connected to the rear wheel. As before, pedals necessarily move in a reciprocating motion, because they are both connected to the same drive wire. Farmos, U.S. Pat. No. 5,496,051, employs two pedals mounted on guides or carriages. The pedals are connected with a wire, although there is a shock absorber connected with the pedals. Each pedal is connected to a chain that drives a partial sprocket. The partial sprockets, through clutch mechanisms, drive a drive sprocket, which is connected to the rear axle. A later Farmos patent, U.S. Pat. No. 6,129,646, employs a similar mechanism. However, here the sprockets connected to the pedal are entirely circular and the chain moves in a generally rotatable motion. The pedals are not connected directly to the drive chain, but rather use a sprocket and clutch mechanism to move the chain when a propulsive force is desired from that particular pedal, but rotate freely on the chain when the pedal is being withdrawn in an upward motion in preparation for the next power stroke. These drive mechanisms employ a linear pedaling motion but still require alternate pedaling motion with a consequent lag of power as the user changes from one leg to another.

Despite this earlier work, no known linear device mechanism is satisfactory. First, each of these earlier devices will either require that the millions of existing bicycles be totally redesigned or discarded. They are not functional as an “add on” to convert a conventional bicycle to the reciprocating linear stroke drive. They cannot be used to convert other devices that employ an axle, crank, pedal mechanism, like a paddle boat, to a linear stroke drive. Second, each of these earlier designs require that the pedal motion be synchronized. That is, as one pedal is moving in one direction, the other pedal is necessarily moving in the opposite direction. As with a conventional bicycle, this causes interruptions in the power stroke to drive the bicycle. Third, these mechanisms do not allow the highly developed and efficient drive sprockets and gear change mechanisms employed on conventional bicycles to be used as designed. These conventional bicycle mechanisms have been in development for well over a century and, as such, are efficient, inexpensive, and in mass production. Consequently, it would be highly desirable to employ the conventional sprockets and gears of a bicycle if possible because of the efficiencies and market economies that are found in this design. It would also be highly desirable to allow at least a limited desynchronization of the pedal motion so that both pedals could simultaneously apply a propulsive force to the bicycle. This would eliminate the loss of power in the transition from one pedal to the other pedal and would allow a user, when required, to use both legs to apply a power stroke to the drive mechanism for the bicycle.

### SUMMARY OF THE INVENTION

The current invention consists of a drive mechanism to provide a maximum and continuous power stroke and to make it possible for both legs of the user to exert a power stroke simultaneously. A first foot pedal and a second foot pedal are mounted on a first and second shuttle respectively. The first foot pedal shuttle, the second foot pedal shuttle, and a third shuttle are disposed for linear motion. Each shuttle is mounted on a rail guide generally linear in shape.

A drive mechanism, usually a chain, extends around two similarly shaped and sized sprockets, one mounted at the top and one mounted at the bottom of the guide rails on one side of the bicycle. The first and third shuttles use a clutch mechanism to grip the drive mechanism. When the first foot pedal shuttle is pushed down the first foot pedal shuttle rail by the user's leg, the clutch mechanism grips the drive mechanism and pulls it along, thus causing rotational motion in the sprockets. Now when the second foot pedal shuttle is pushed down its rail, an upward movement is imputed to the third shuttle, moving it up its rail. A clutch mechanism in this shuttle grasps the drive mechanism and pulls it along in the upward direction causing continued rotation of sprockets. Thus, the two pedal shuttles are respectively employed to move the drive mechanism around the sprockets causing a rotational motion in the sprockets. One or more of these sprockets mounted on the guide rail may be employed, through appropriate gears and other sprockets, to drive one of the wheels of the bicycle. The two pedal shuttles are elastically connected to each other, so that moving one pedal shuttle exerts an elastic force on the other pedal shuttle to cause it to move in the opposite direction. However, the elastic connection between the two pedal shuttles allows both pedal shuttles to move independently of each other within the limits of the elastic connection. Thus, a user may begin to depress one pedal before the downward motion of the other pedal has stopped. This desynchronized pedaling keeps continuous force moving the driving mechanism to drive the sprockets and employing the force of both pedal shuttles to drive the rotational motion of the sprockets during the change of direction of the leg movement. This maximizes the torque transmitted to the bicycle wheels during a change from one leg to another during pedaling rather than the loss of torque seen in earlier bicycle drive designs.

The current invention may be mounted to an existing bicycle using the existing sprockets and gear mechanisms of the bicycle. The central axle on a bicycle on which the pedals and gear mechanisms are mounted may be replaced or extended to allow for the connection between one of the sprockets mounted on the pedal guide rails and the sprockets and axle that are used to drive the rear wheel of the bicycle. Conversely, a bicycle could be specially designed to use this device, but still allowing standard gear mechanisms and sprockets to be employed as are part of the drive mechanism for that specially designed bicycle. Other devices that employ a pedal, crank, sprocket mechanism to drive a rotary motion, such as a paddle wheel boat, could also be converted to use this drive mechanism.

### BRIEF DESCRIPTION OF THE DRAWINGS

FIG. 1 shows the current invention mounted on a bicycle as seen from the right.

FIG. 2 shows the current invention mounted on the left side of a bicycle.

FIG. 3A shows a portion of this invention seen from the left side.

FIG. 3B shows how the right pedal transmits force to drive a sprocket.

FIG. 4A shows the invention in a view from the front.

FIG. 4B shows in detail a portion of the invention that connects the two pedal shuttles to each other.

FIG. 5 shows an embodiment of the clutch mechanisms used to grip the drive element.

FIG. 6 shows a portion of the apparatus that mounts the current invention to an existing bicycle.

FIGS. 7A and 7B show an alternative construction for the shuttles that drive the power sprocket.

### DETAILED DESCRIPTION OF THE DRAWINGS

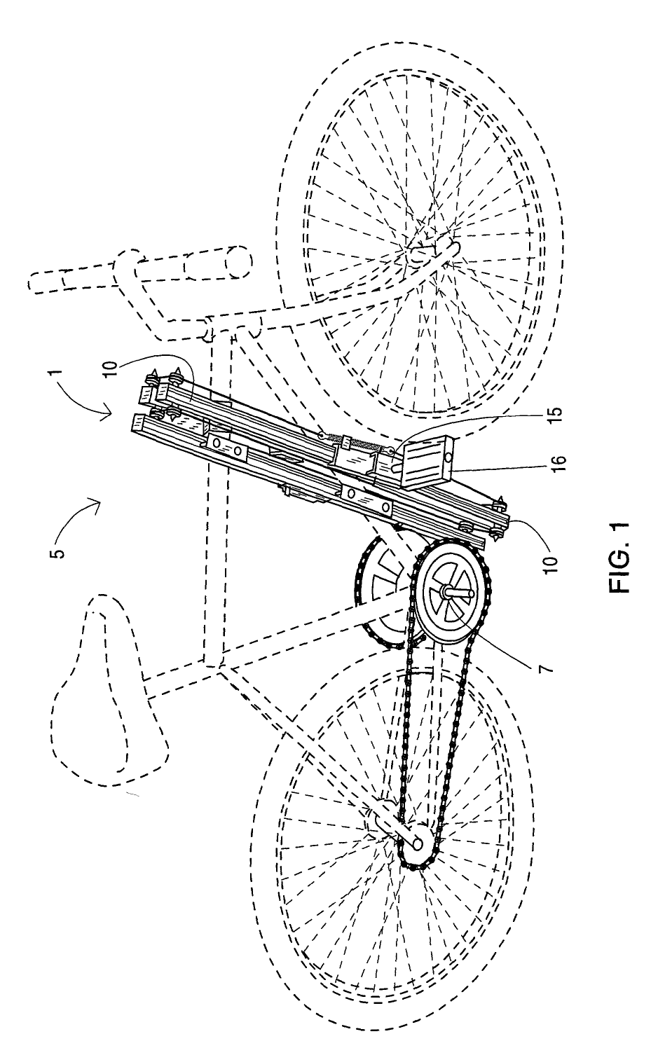

FIG. 1 is the drive mechanism (1) mounted on a bicycle seen from the perspective in which the view is toward what would be the right side of a user mounted on the bicycle (5). This will be referred to as the right side of the bicycle (5). The opposite side of the bicycle (5) will be referred to as the left side of the bicycle (5).The axle (7), sprockets, and gears on the right side of the bicycle (5) are shown in solid lines and are much like that on any standard bicycle (5). Missing from the right side of the bicycle (5) is the pedal and crank that connects to the axle (7). The viewer will also notice mounted on the right side of the bicycle and, in effect, replacing the pedal and crank is a right shuttle rail (10) of the drive mechanism (1). Mounted to the right shuttle rail (10) is a right pedal shuttle (15). On the right pedal shuttle (15) is a right pedal (16). The user will place their right foot on the right pedal (16) and exert a downward force on the right pedal (16). Because the right pedal (16) is connected to the right pedal shuttle (15), the force on the right pedal (16)will force the right pedal shuttle (15) on the right shuttle rail (10) in a downward direction away from the handlebars of the bicycle (5) and toward the ground. The right shuttle rail (10) is designed to guide the right pedal shuttle (15) in a generally straight line without twisting or turning. The precise length and angular orientation of the right shuttle rail (10) is a matter of manufacturing convenience and design choice. As shown in FIG. 1, the right shuttle rail (10) extends from above the upper horizontal frame of the bicycle (5) that connects the handlebars and seat all the way to a point below the axle (7). Moreover, the right shuttle rail (10) is angled so that the upper end of the right shuttle rail (10) is closer to the handlebars than would be the case if the right shuttle rail (10) was perpendicular to the surface on which the bicycle (5) was being ridden. Individual users may wish to vary the angle at which the right shuttle rail (10) is mounted. It may also be that the length of the right shuttle rail (10) may be significantly shorter than is shown in FIG. 1 or slightly curved. However, these features of the right shuttle rail (10) can be varied without affecting the overall functioning the drive mechanism (1).

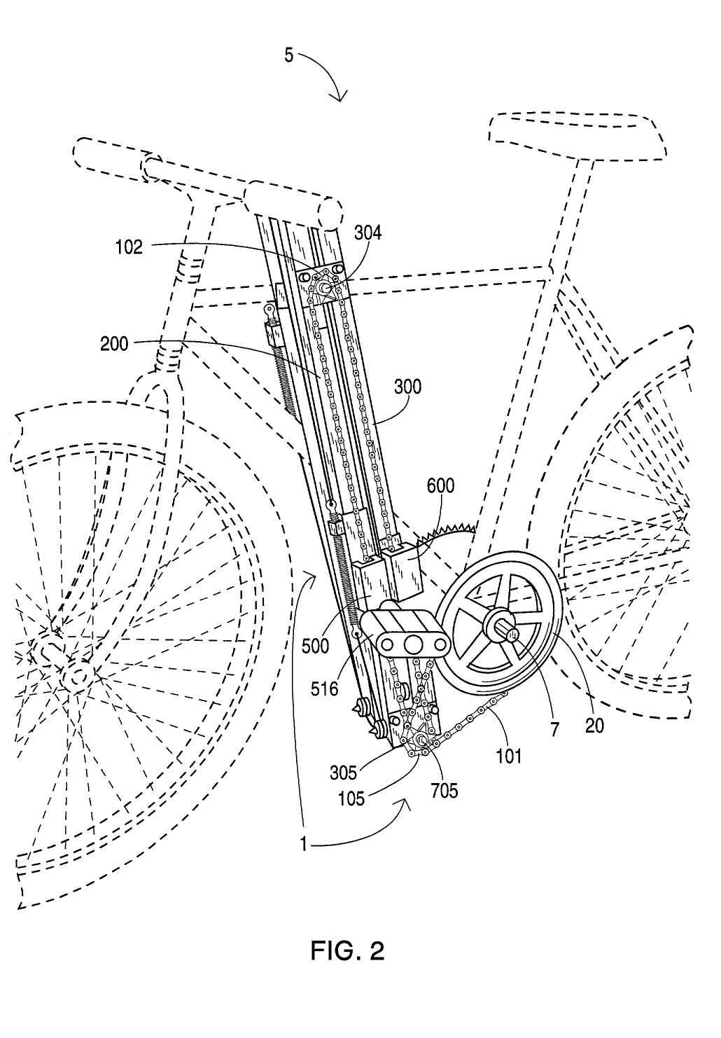

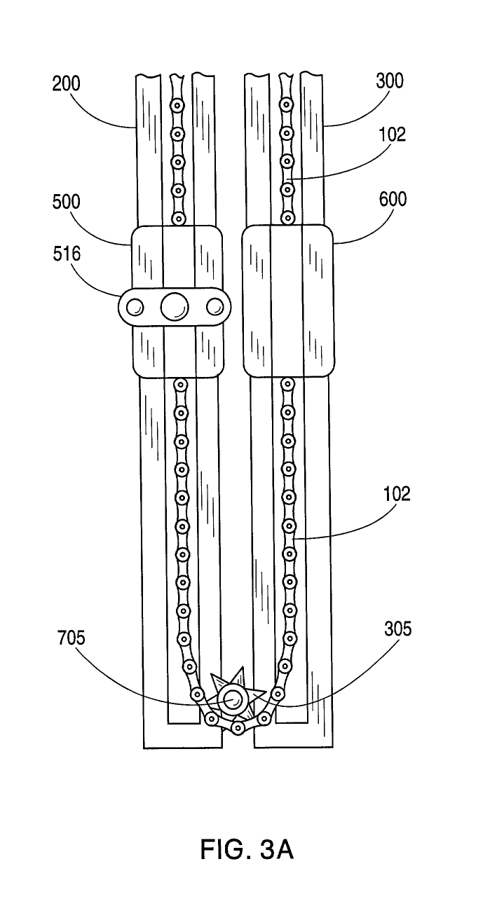

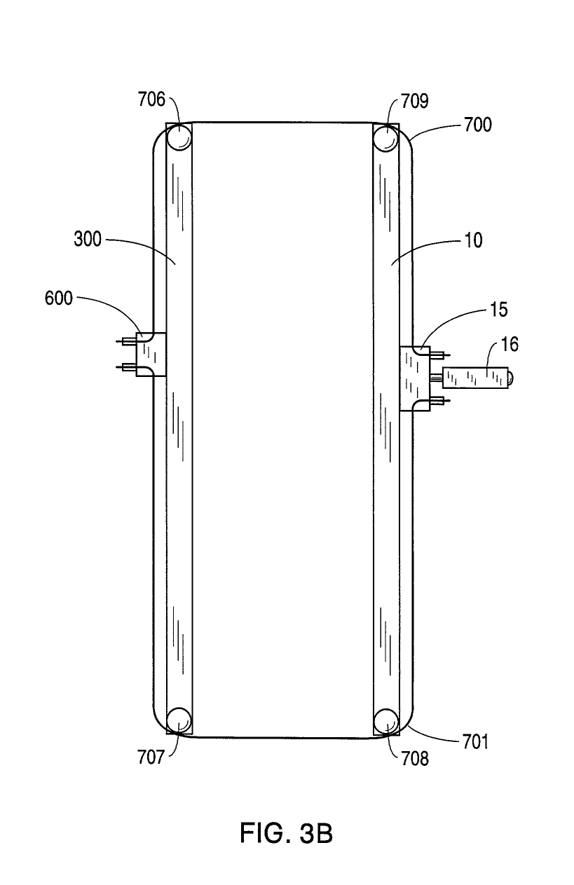

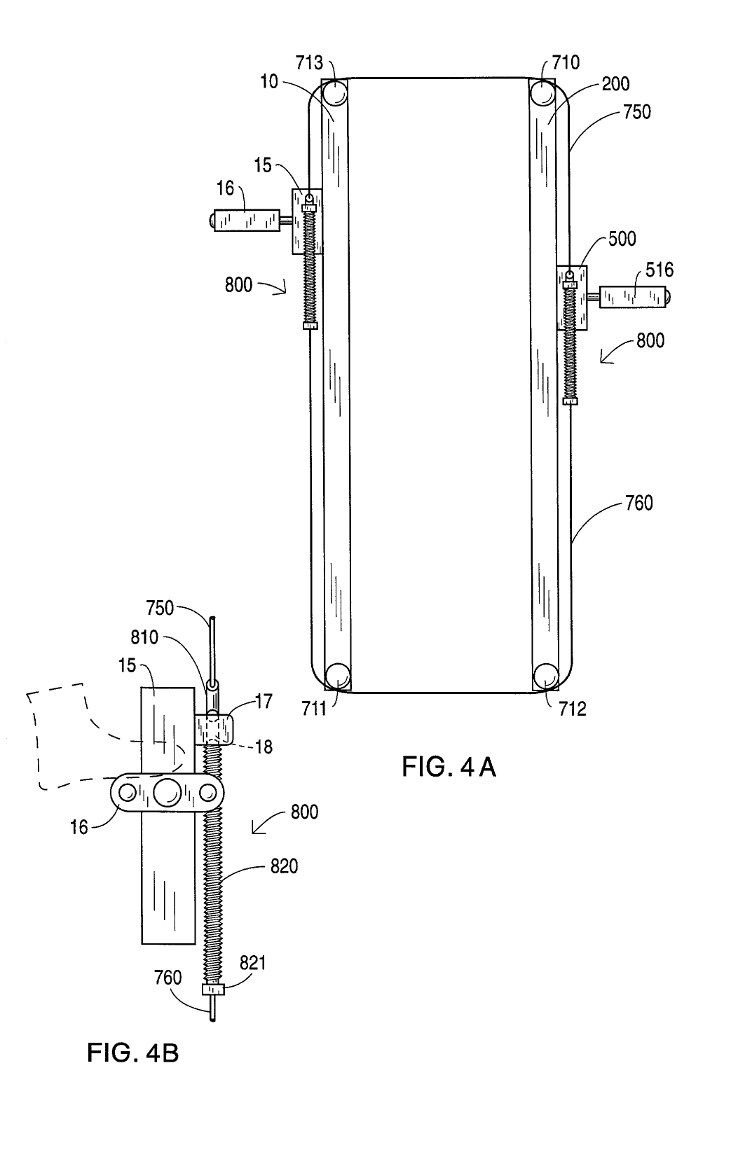

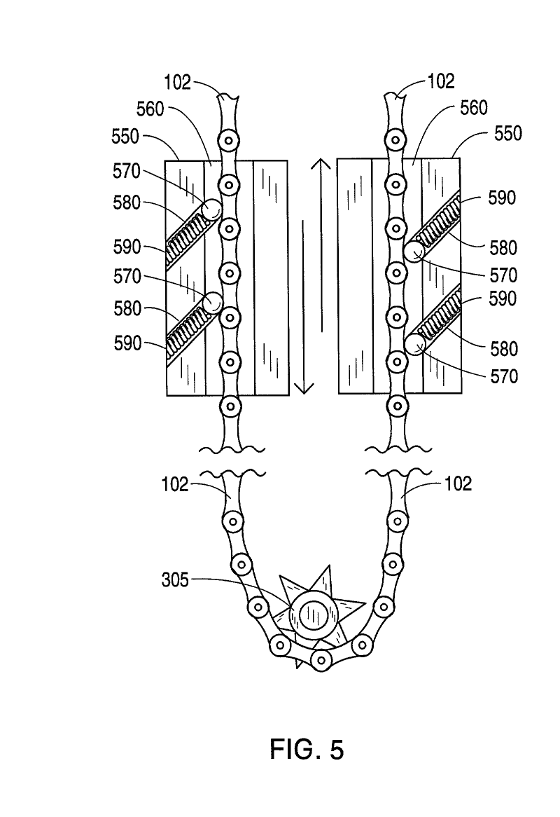

FIG. 2 shows the part of the drive mechanism (1) mounted on the left side of the bicycle (5). Ordinarily, on the left side of a bicycle, a pedal and crank extend from the axle (7). The user's left foot will rest on the pedal and will be used to provide power by pedaling the pedal with the resulting motion in the crank. There is no conventional bicycle pedal and crank extending from the left side of the axle (7), as shown in FIG. 2. However, a left drive sprocket (20) is now mounted on a new and longer axle (7) or on an extension of a conventional axle (7). The left drive sprocket (20) is connected by first driving element (101), usually a chain, to a power sprocket (105) mounted at the bottom of left pedal shuttle rail (200) and left shuttle rail (300). Left pedal shuttle rail (200) guides a left pedal shuttle (500) which has a left pedal (516) attached. Left shuttle rail (300) is adjacent to left pedal shuttle rail (200) and approximately parallel to it. Left pedal shuttle rail (200) will ordinarily be parallel and adjacent to the right shuttle rail (10) mounted on the right side of the bicycle (5). The left pedal shuttle rail (200) and right shuttle rail (10) are separated by the frame of the bicycle and mounted to the bicycle frame. Between the left pedal shuttle rail (200) and left shuttle rail (300), two sprockets are disposed. The upper rail sprocket (304) is located at the upper end or top of the left pedal shuttle rail (200) and the left shuttle rail (300). The lower rail sprocket (305) is largely hidden in this view, but is located at the lower end or bottom of and between left pedal shuttle rail (200) and left shuttle rail (300). The second driving element (102) rotates around the upper rail sprocket (304) and the lower rail sprocket (305). The power sprocket (105), which drives the first driving element (101) to rotate the left drive sprocket (20), is mounted on a power axle (705) along with the lower rail sprocket (305). The power sprocket (105) and the lower rail sprocket (305) interlock with each other and allow changing of the power sprocket (105). The functioning of the upper rail sprocket (304), lower rail sprocket (305), the left pedal shuttle (500) and left shuttle (600) and how operation of the right pedal shuttle (15) the left pedal shuttle (500) and the left shuttle (600) operate to drive the rotation of the power sprocket (105) will be explained further in FIGS. 3A, 3B, 4A and 4B.

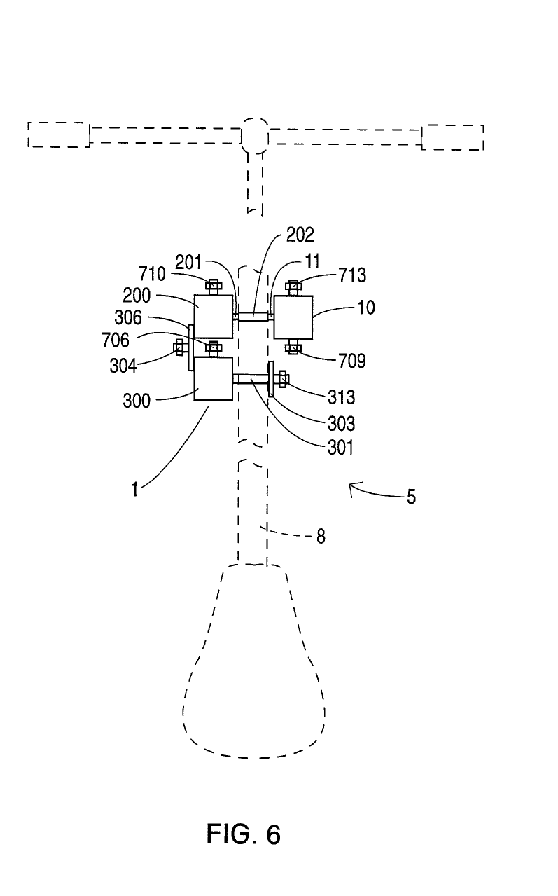

FIG. 3A is a drawing of the bottom portion of the left pedal shuttle rail (200), left shuttle rail (300), left pedal shuttle (500), and left shuttle (600) which also shows lower rail sprocket (305). The bicycle itself is omitted from this figure for clarity as well as the remainder of the drive mechanism (1). A second driving element (102), usually a chain or belt, rotates around the lower rail sprocket (305) and the upper rail sprocket (304). The lower rail sprocket (305) is mounted on the power axle (705) as is the power sprocket (105) (not shown) which, through the first driving element (101) (not shown), drives the left drive sprocket (20) (not shown). The second driving element (102) passes through a bore in a clutch element (550) (not shown) in both the left pedal shuttle (500) and left shuttle (600). The clutch element (550) is seen in FIG. 5. A left pedal (516) is mounted on the left pedal shuttle (500). The second driving element (102) passes through a bore in a clutch element (550) (shown in FIG. 5) which releasably grips the second driving element (102). A clutch element (550) (not shown in this drawing) is constrained to grip the second driving element (102) when the left pedal shuttle (500) is being forced in a downward direction by the left pedal (516) toward the lower rail sprocket (305). When the left pedal shuttle (500) is moving away from the lower rail sprocket (305) or in an upward direction the clutch element (550) (not shown) disengages and allows the second driving element (102) to move freely through the bore in the clutch element (550) (not shown) mounted on the left pedal shuttle (500). The left shuttle (600) operates in a similar fashion with a clutch element (550) (not shown) mounted on the left shuttle (600) to grip the second driving element (102). However, here a clutch element (550) (not shown) grips the second driving element (102) when the left shuttle (600) is moving in an upward direction—that is, away from the lower rail sprocket (305). Thus, when the left pedal shuttle (500) is moving in a downward direction, the second driving element (102) is gripped by a clutch element (550) mounted on the left pedal shuttle (500) and is forced in a rotational movement around the upper rail sprocket (304) and the lower rail sprocket (305), thus causing a counter-clockwise motion of the lower rail sprocket (305). Likewise, when the left shuttle (600) is moving in an upward direction, a clutch element (550) (not shown) grips the second driving element (102), pulling it upwardly, again forcing a counter-clockwise rotation of the lower rail sprocket (305). The precise length and angular orientation of the left pedal shuttle rail (200) and left shuttle rail (300) like the right shuttle rail (10) is a matter of manufacturing convenience and design choice. The left pedal shuttle rail (200) and the left shuttle rail (300) must be approximately parallel to the right shuttle rail (10), but their respective length and angular orientation can be varied without affecting the overall functioning of this invention. It will be noted in FIG. 2 that the lower rail sprocket (305) and the upper rail sprocket (304) are approximately the same size. The second driving element (102) rotates around the upper rail sprocket (304) and the lower rail sprocket (305). Thus, the second driving element (102) forms an elongated loop around the lower rail sprocket (305) and the upper rail sprocket (304) with the lengthwise sections of the loop extending from one sprocket to the other being generally parallel to each other. In most circumstances, this bicycle drive mechanism will be used with only one leg engaging in a power stroke at one time. If only one leg is engaging in a power stroke, then the left pedal shuttle (500) and the left shuttle (600) are moving together in a synchronized fashion in the same direction and speed as they travel on respectively the left pedal shuttle rail (200) and the left shuttle rail (300). If the left pedal shuttle (500) and the left shuttle (600) are moving in a synchronized fashion, then only one of the clutch elements (550) is engaging the second driving element (102). For example, if the left pedal shuttle (500) and the left shuttle (600) are moving away from the lower rail sprocket (305) toward the upper rail sprocket (300), then ordinarily only the clutch element (550) on the left shuttle (600) will be gripping the second driving element (102). On those occasions when desynchronized pedaling is desired—such as at the end of a power stroke by one leg and the beginning of a power stroke by the other leg—the motion of the left pedal shuttle (500) and the left shuttle (600) are no longer synchronized so that the left pedal shuttle (500) may be moving downwardly toward the lower rail sprocket (305) while the left shuttle (600) is moving upwardly toward the upper rail sprocket (304) and both clutch elements (550) are engaged and gripping the second driving element (102). It will be difficult, if not impossible, to achieve the desynchronized pedaling using a single second driving element (102) unless the portions of the second driving element (102) moving around the two sprockets were approximately parallel to each other. If the two portions were not parallel then the shuttle rails (200) and (300) could not be parallel to each other and parallel to the two portions of second driving element (102). If the shuttle rails (200) and (300) were not parallel to each other, the left pedal shuttle (500) and the left shuttle (600) could not move up and down the shuttle rails (200) and (300) parallel to each other. Thus, the tension of second drive element (102) would not remain constant as the shuttles (500) and (600) moved from one end of rails (200) and (300) to the other end of rails (200) and (300).

As seen in FIG. 2, the lower rail sprocket (305) and power sprocket (105) are mounted on the power axle (705) so that when the lower rail sprocket (305) rotates the power sprocket (105) rotates in a matching circular motion. It will readily appreciated by one of skill in the art that the power sprocket (105) could be removably mounted to the power axle (705). This would allow a user to change the power sprocket (105) for different applications. Where the bicycle is to be used over relatively flat, paved terrain, the power sprocket (105) might have a larger number of teeth giving an overall higher rate of speed for the bicycle but sacrificing torque. Conversely the power sprocket (105) with a lower number of teeth would reduce the top speed of the bicycle but would increase the torque, which might be necessary should the bike be used in off-road terrain, in deep sand or mud, or in other venues where applying a higher torque to the wheels is more desirable than applying a high rate of rotation to the bicycle wheels.

FIG. 3B is a stylized figure to show the relationship of the right pedal shuttle (15) and right pedal (16) and the right shuttle rail (10) to the left shuttle rail (300) and the left shuttle (600). The bicycle (5), which is ordinarily between the two rails (10, 300), is omitted from this view for clarity. Connecting elements (700) and (701) are usually loops of coated wire connecting the left shuttle (600) and the right pedal shuttle (15). Essentially a coated wire is connected to the right pedal shuttle (15) where it will usually be attached in a way that will allow adjustment by a tensioning screw or the like. The connecting element (700) runs from the top or upper side of the right pedal shuttle (15) over the top of the right shuttle rail (10) to a pulley (709) which redirects it laterally to another pulley (706) which redirects the connecting element (700) downwardly to left shuttle (600) where it is attached to left shuttle (600) with a tensioning screw. Another connecting element (701) runs from the bottom of the right pedal shuttle (15) through a pulley (708) then another pulley (707) and to the bottom of the left shuttle (600) where it is attached by a tensioning screw. Usually a coated wire or some similar flexible but inelastic material will be used for the connecting elements (700) and (701). The connecting elements (700) and (701) will be attached to the right pedal shuttle (15) and left shuttle (600) using tensioning screws to achieve an appropriate tension in the connecting elements (700) and (701). Thus when the user places a foot on the right pedal (16) and forces the right pedal shuttle (15) downward, the connecting element (700) will be pulled down, and passing over the pulleys (709) and (706) will exert an upward force on the left shuttle (600). A clutch element (550) (not shown in this figure) in the left shuttle (600) will grip the second driving element (102) (not shown in this figure) pulling it upwardly along with the left shuttle (600). This causes a counter-clockwise rotation of the lower rail sprocket (305) (not shown).

FIG. 4A is a stylized view from the front of the bicycle (5), showing the connection of the right pedal shuttle (15) and left pedal shuttle (500), although the bicycle (5), mounted between the shuttles (15, 600), is omitted from this view. Other parts of the drive mechanism (1) are also omitted for simplicity's sake. The purpose of FIG. 4A is to illustrate how the right pedal shuttle (15) and the left pedal shuttle (500) operate together. In FIG. 4A from the viewer's perspective, the right shuttle rail (10) is on the left side of the viewer and the left pedal shuttle rail (200) is on the right hand side of the viewer. The right pedal shuttle (15) and the left pedal shuttle (500) with their respective pedals (16) and (516) are seen protruding from the right pedal shuttle (15) and the left pedal shuttle (500). The pedal shuttles (15) and (500) respectively move up and down in their respective shuttle rails (10) and (200). The left and right pedal shuttles (15) and (500) are connected by connecting elements (750) and (760), usually coated wire, and mounting devices (800). The upper connecting element (750) and the lower connecting element (760) loop around respectively pulleys (713) and (710) and (711) and (712) to connect to a mounting device (800) on each pedal shuttle (15) and (500). How the connecting elements (750) and (760) connect to a mounting device (800) is seen more clearly in FIG. 4B. It will be noted in both FIGS. 1 and 2 there is an eye bolt type connection at both the top and bottom of the mounting device (800), while in FIGS. 4A and 4B there is an eye bolt at the top of the mounting device (800) but not at the bottom. The particular mechanism employed to connect the connecting elements (750) and (760) to the mounting device (800) is unimportant so long as the length of the connecting elements (750) and (760) are easily adjusted. Thus, for example, an eye bolt type connection would allow the connecting element (750) to be looped back on itself, then tightened into place with a clamp using nuts and bolts. This type of clamp is commonly used to connect coated wire to a fixed eye bolt or point. In FIGS. 4A and 4B, at the bottom on the mounting device (800) the connecting element (760) simply threads in to the mounting device (800) and would be secured in a bore in the mounting device (800) in any convenient fashion. This would allow the connecting element (760) to be easily adjusted based on the length on the rigid rod (810) and the bore therein. Moreover, because the connecting elements (750) and (760) are ordinarily made of coated wire, should an adjustment of the length of these two elements be required, it will be a simple matter to replace the coated wire with different lengths of coated wire for connecting elements (750) and (760). The expense of this would be relatively small, because coated wire is widely available in hardware stores at reasonable prices. The exact manner of connecting coated wires to the mounting device (800) is a matter of design and convenience so long as it allows the lengths of connecting elements (750) and (760) to be easily adjusted in accordance with the needs of the user, as is described later in this application.

FIG. 4B shows the mounting device (800) as attached to right pedal shuttle (15). For brevity, the duplicate mounting device (800) on the left pedal shuttle (500) is not shown. The mounting device (800) consists of a rigid rod (810) with points of connection at the top for the connecting element (750) and at the bottom for the connecting element (760). The right pedal shuttle (15) has a protruding piece (17) with a protruding piece bore (18) therethrough. The rigid rod (810) passes through the protruding piece bore (18) on the protruding piece (17) on the right pedal shuttle (15). This allows the right pedal shuttle (15) to slide up and down on the rigid rod (810). However, a spring (820) is also mounted on the rigid rod (810). The spring (820) is restrained against the bottom of the rigid rod (810) against a spring stop (821) and is biased to hold the right pedal shuttle (15) at or near the top of the mounting device (800). The location of the spring stop (821) on the rigid rod (810) may be adjustable so as to adjust the tension in the spring (820) and the amount of movement along the rigid rod (820) permitted for the right pedal shuttle (15). Seen in FIG. 4B in broken lines is the foot of the user on the right pedal (16).

Referring to FIG. 4A, when the user makes a pedaling motion with his right leg downward on the right pedal (16) when the right pedal shuttle (15) is located near the top of rail (10), the user will lift his left leg and foot on the left pedal (516) to avoid excessive downward pressure on left pedal (516) which will be located near the bottom of left pedal shuttle rail (200) when right pedal shuttle (15) is near the top of right shuttle rail (10). This leg and foot lift coupled with the natural pressure of springs (820) keeps the spring (820) in the decompressed state on both pedal shuttles (15) and (500) and thus the left pedal shuttle (500) maintains its most suitable position for its next power stroke which starts before the power stroke of the right pedal shuttle (15) is ended by the user. When the right pedal shuttle (15) nears the bottom of right shuttle rail (10), the user applies force to the left pedal (516), which is now near the top of the left pedal shuttle rail (200), which starts the left pedal shuttle (500) moving in a downward direction from the top of the left pedal shuttle rail (200) as the right pedal shuttle (15) is still moving down but near the end of right shuttle rail (10). The movement of the right pedal shuttle (15) and the left pedal shuttle (500) in a downward direction at the same time causes the springs (820) on the right pedal shuttle (15) and the left pedal shuttle (500) to start compressing. However, when the spring (820) on both pedal shuttles (15) and (500) becomes fully compressed as the left pedal shuttle (500) continues its downward movement, the right pedal shuttle (15) is forced to start moving up the right shuttle rail (10). Thus, the power stroke by the right pedal shuttle (15) is ended by the user. During its movement and before the right pedal shuttle (500) reaches the top of the right shuttle rail (10), the user lifts the right leg and foot, which reduces the downward force on the right pedal (16) and the spring (820) This leg lifting plus the natural force of the spring (820) allows the compressed spring (820) on both the pedal shuttles (15) and (500) to decompress and in so doing this moves the right pedal shuttle (15) in position for its next power stroke. Thus, the decompressed spring (820) on both mounting devices (800) are now elastic and prepared to allow for desynchronized motion during the next directional change in leg and shuttle movement.

When the user makes a pedaling motion downward on the right pedal (16), this motion starts compressing the spring (820) which pushes against the spring stop (821) on the rigid rod (810) on the mounting device (800) on the right pedal shuttle (15). As the spring (820) compresses, the connecting element (750) is pulled down and a upward force is transmitted through the pulleys (713) and (710) to the rigid rod (810) on the mounting device (800) on left pedal shuttle (500) mounted on the left side of the bicycle (5). This will pull the rigid rod (810) on the mounting device (800) for left pedal shuttle (500) upward. However, the left pedal shuttle (500) need not move in response to the force exerted by the connecting element (750). The shuttle may remain stationary as the rigid rod (810) moves through the protruding piece bore (18) on protruding piece (17) on the left pedal shuttle (500) although the upward motion is compressing the spring (820). Depending on how long the rigid rod (810) is and how stiff the spring (820) is, a substantial amount of play will be allowed between the two pedals (16) and (516) and the two pedal shuttles (15) and (500). Moreover, the spring stop (821) may be made adjustable. For example, the rigid rod (810) could be threaded, with the spring stop (821) simply made from bolts to adjust along the threads on the rigid rod (810). Thus, adjusting the spring stop (821) will also adjust the tension in the spring (820) and the amount of movement of the pedal shuttles (15) and (500) along their respective mounting device (800). It should be noted that the means of connecting the right pedal shuttle (15) and the left pedal shuttle (500) differ significantly and functionally from the way the right pedal shuttle (15) is connected to the left shuttle (600). The connecting mechanism (800) with the rigid rod (810) and the spring (820) allows for a substantial amount of play in the motion of the right pedal shuttle (15) and the left pedal shuttle (500). That is, they may both move in the same direction within the limits provided by the rigid rod (810) and the spring (820) in each mounting device (800). On the other hand, as shown in FIG. 3B, the right pedal shuttle (15) is connected to the left shuttle (600) by flexible, but inelastic, connecting elements (700) and (701). Thus, when the right pedal (16) is being pedaled downward by a user's right leg, forcing the right pedal shuttle (15) downward, the left shuttle (600) is necessarily being pulled upward by the connecting element (700). The left shuttle (600) and its clutch element (550) is engaging the second driving element (102) and pulling it in an upwardly direction, thus causing a counter-clockwise rotation of the lower rail sprocket (305). Whenever the right pedal shuttle (15) is moving downwardly, the left shuttle (600) is always moving upwardly and providing a counterclockwise rotational impetus to the lower rail sprocket (305). Functionally this means that the left pedal shuttle (500) and the right pedal shuttle (15) can both be moving downwardly and providing a power stroke simultaneously within the limits of the dimension of the connecting mechanism (800). This means that the pedaling motion need not be synchronized. In other bike driving mechanisms, only one foot at any time is exerting a downward force on a pedal. In conventional pedal drives, as the pedals move through the approximate twelve and six o'clock positions, little, if any, force can be exerted by a user on the drive mechanism. This creates a lag of power in which, as the pedals rotate through the eleven to one o'clock position on the left and right sides respectively. As the pedals are in the eleven to one o'clock position or in the five to seven o'clock position, little power is applied for this portion of the pedal rotation, approximately 15% of the time. However, the desynchronized pedaling motion of this invention allows a continuous pedaling motion in which one pedal can be depressed even as the other pedal is also being depressed. Thus, there is no loss of momentum with increased efficiency and torque of the driving mechanism. Moreover, under unusual circumstances where a high degree of torque is required through the drive mechanism (1), both pedals may be depressed simultaneously, allowing both legs to exert a driving force on the second driving element (102). In an ordinary bicycle, in the period of transition from the power stroke from one leg to the other leg, there is a loss of power. However, with a desynchronized pedaling motion permitted under the design of this invention, the user will learn to begin the power stroke of one leg shortly before the power stroke is finished on the other leg. The spring (820) in the connecting mechanism (800) will cushion any shock to the legs of the user, but will allow for a moment in which the second driving element (102) is being driven by the force of both legs. Thus, rather than a loss of power in the transition from one leg to the other, there is a doubling of power in the transition from one leg to the other leg in this mechanism, an effect that is completely new in pedal drive mechanisms used for bicycles. While it is impossible to predict in what fashion this invention will be used once it is in widespread use, it is anticipated that it will be widely used in off-road, rough terrain, loose, sandy soil, mountain bike-like applications. In these applications, the ability to apply a continuous power stroke, maximizing torque during transition from one pedal to another, and the opportunity to apply a power stroke with both pedals simultaneously is particularly beneficial.

In a conventional bicycle, maximum pedaling efficiency is achieved when the user's position on a seat allows the user to pedal, with maximum efficiency, using the large muscles of the legs and particularly the thighs. This is ordinarily achieved when the pedals are positioned at or near the end of a user's extended legs. The user's leg that is powering the pedal is almost, but not quite, fully extended. Consequently, bicycles are sold with different frame sizes and with adjustable seats, so that buying a bicycle with an appropriate frame and by adjusting the seat height one is able to achieve an efficient pedaling motion. However, in this motion the actual power stroke, as was described earlier, is when the pedals move through the appropriate portions on the clock face if the pedal is viewed as having a rotary motion—that is, from approximately 1:30 to 5:30 for the pedal that moves in a clockwise rotation or conversely from approximately 10:30 to 7:30 for the pedals that move in a counter-clockwise rotation. However, for serious bicyclists, a custom designed frame will be required to achieve the maximum efficiency. The need for this custom frame is dictated by the central axle placement in a standard bicycle design on which the pedals and pedal cranks are mounted. However, the drive mechanism (1) of this invention makes such custom designed frames unnecessary. First, the right shuttle rail (10) and the left pedal shuttle rail (200) were designed to be significantly longer than are required for an efficient pedaling stroke. That is, most people take a relatively short pedal stroke like the way most people use a stair climber taking relatively short steps as opposed to moving the legs through the full range of motion made possible by the hip and knee joints. For example, if the user decides to take an 8-inch power stroke with each leg, then the right pedal shuttle (15) and the left pedal shuttle (500) will be mounted opposite from each other with at least six inches of room from either the top or the bottom of the right shuttle rail (10) and the left pedal shuttle rail (200). When the right pedal shuttle (15) and the left pedal shuttle (500) are mounted opposite from each other, they are in position to begin the power stroke. As the user pushes down on one pedal, the other pedal will, through the connecting mechanism (800), move in the opposite direction while allowing for desynchronization. As, for example, the right pedal shuttle (15) moves down four inches, the left pedal shuttle (500) will move up four inches and they will now be separated from each other on their respective rails by eight inches. At that point, the user would begin the power stroke with the left leg pushing downwardly on the left pedal (516). The right pedal shuttle (15) might continue down within the limits of the connecting mechanism (800) allowing for desynchronized pedaling, but then it will begin its upward motion. As can be seen by adjusting the length of the connecting elements (750) and (760), the point where the right pedal shuttle (15) and the left pedal shuttle (500) are opposite from each other can vary significantly over the length of the respective right shuttle rail (10) and left pedal shuttle rail (200). Consequently, to adjust the pedal positions to fit a user's leg length, it is not necessary to adjust the frame of the bicycle, but only the length of the connecting elements (750) and (760). For standard size bicycle frames, the right shuttle rail (10) and the left pedal shuttle rail (200) may be made more than 20 inches in length while still fitting comfortably on the bicycle frame and without unduly extending above or below the portion of the frame on which the right shuttle rail (10) and the left pedal shuttle rail (200) are mounted. Assuming most people take an 8-inch or 9-inch pedal stroke, then more than 10 inches of adjustment will be allowed in the mounting of the pedals while still accommodating the preferred power stroke of that user. Consequently, it will be unnecessary to adjust the bicycle frame, but simply to adjust the length of the connecting elements (750) and (760) to achieve the desired position for a particular user. For a user who is involved in competitive bicycling where weight may be at a premium, the left pedal shuttle rail (200) and the right shuttle rail (10) can be custom designed for that user, but even so, this is far easier than building a bicycle frame from scratch as is required to achieve a custom fit in a conventional bicycle design. In a conventional pedal drive for a bicycle, the axle, crank, pedal arrangement is a given. The remainder of the bicycle, including how a user makes use of it, must fit that arrangement of the axle, cranks, and pedals. However, in the drive mechanism (1) of this invention, the user controls how the drive mechanism (1) is employed. One user may prefer a 10-inch stroke, while another may prefer a 3-inch stroke. Both are easily accommodated within the current design without any changes. One user may prefer to pedal with the pedals opposite from each other at a position high on the pedal guide rails, while another may prefer to pedal with the pedals opposite from each other at a position much lower on the pedal guide rails. Nothing more is required to accommodate this user than to change the length of the connecting elements (750 and (760). It is believed, once use of this drive mechanism (1) becomes widespread, only one, or at most a few, bicycle frame sizes will be required with the adjustments being made in the length of the shuttle guide rails of this invention and of the elements that connect the pedal shuttle to custom fit a bicycle to a particular user.

FIG. 5 shows in detail clutch elements (550) that are mounted respectively in or on the left pedal shuttle (500) and the left shuttle (600) with second driving element (102) shown passing through the clutch bore (560) in the clutch element (550). FIG. 5 shows details of the clutch elements (550) as it grips the second driving element (102) for motion. The two clutch elements (550) shown in FIG. 5 are identical but for their orientation relative to the second driving element (102). In viewing FIG. 5 from the viewer's perspective, the left clutch element (550) is mounted on the left pedal shuttle (500) (not shown). The second driving element (102) passes through a clutch bore (560) in the clutch element (550). There are two ball bores (590) oriented generally upwardly. A spring (580) is positioned in each ball bore (590) to bias a ball (570) for pressure against the second driving element (102). In this drawing, the second driving element (102) is a chain and the ball (570) biased for pressure by the springs (580) to wedge against the links in the chain forming second driving element (102). When the clutch element (550) on the left is going downwardly as shown by the arrow, the balls (570) wedge between the links in the chain as the chain narrows at the point of connection for the chain links, fixing the second driving element (102) in place within the clutch element (550), thus, forcing the second driving element (102) downwardly conforming its motion to the motion of the left pedal shuttle (500) (not shown) when forced downward by a user who exerts pressure on the left pedal (516) (not shown). It will be readily appreciated that the clutch element (550) mounted on the right in FIG. 5 from the viewer's perspective is on the left shuttle (600) (not shown). Here, the orientation of the ball bores (590) is generally downwardly causing the balls (570) to wedge between the wide and narrow points in the links in a chain forming second driving element (102) so that, when the left shuttle (600) is moving upwardly as is shown by the arrow, the balls (570) will wedge between the wide and narrow points in the links in the second driving element (102) pulling it generally upwardly. In this fashion, the chain links in the second driving element (102) pass around the sprocket (305) causing a counter-clockwise rotation of the sprocket (305) as the left pedal shuttle (500) and left shuttle (600) exert a driving force on the second driving element (102) through the clutch elements (550). It would be understood by one of ordinary skill in the art that the clutch elements (550) could be replaced with different mechanisms including sprocket mechanisms using an unidirectional clutch instead of the ball bore (590), spring (580), and ball (570) arrangement shown here. The precise design of the clutch mechanism (550) is unimportant so long as it serves to impart a one-way force to a second driving element (102) corresponding to the force being exerted by a user respectively on the left pedal shuttle (500) by forcing the left pedal (516) downwardly or by pressing the right pedal (16) downwardly which forces the left shuttle (600) upwardly, thus imparting a counter-clockwise rotation through the second driving element (102) to the lower rail sprocket (305). Probably for the foreseeable future, mechanical technology will be employed for the clutch element (550). With mechanical technology, there is a short period as the clutch element (550) moves along the second driving element (102) before a point is reached where the clutch element (550) engages to begin to grip the second driving element (102) to force the second driving element (102) to move in the same direction as the clutch element (550). As was explained in FIGS. 4A and 4B, the right pedal shuttle (15) and the left pedal shuttle (500) may both be applying a power stroke simultaneously. However, for a pedal to apply a power stroke to the second driving element (102), the clutch element (550) must be engaged and gripping the second driving element (102). Therefore, in order to apply power strokes with both pedals, the left pedal (516) and the right pedal (16), there is a minimum amount of desynchronized pedal motion which must occur before a clutch element (550) can engage to grip the second driving element (102). For the type of clutch element (550) shown in FIG. 5, this minimum length of desynchronization movement before the clutch element (550) could engage would be approximately the length of one link in the chain. This means that the mounting element (800) or any other elastic connection between the right pedal shuttle (15) and the left pedal shuttle (500) must allow more than the length of a chain link of desynchronized motion for the clutch element (550) to begin to engage and to grip the second driving element (102). Moreover, for the desynchronized pedaling to be effective in providing a smooth continuous power stroke, there must also be an additional amount of desynchronized pedal movement above the minimum amount required to engage the clutch element to allow a smooth transition from the power stroke from one leg to another. It is believed that the minimum effective amount of desynchronized pedal motion for clutch engagement should be at least one-half inch and the minimum amount of desynchronized pedal movement to allow effective transition from one leg to another should be at least two inches.

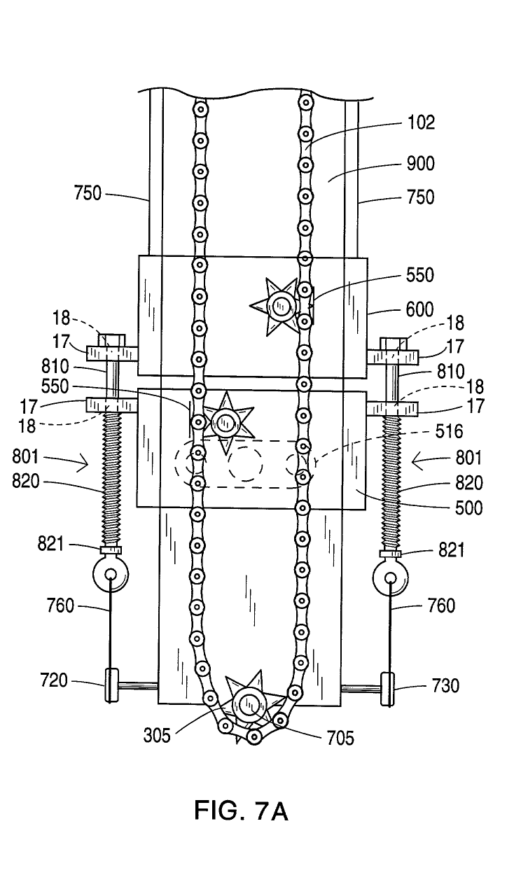

FIG. 6 shows the mounting of the right shuttle rail (10), the left pedal rail (200), and the left rail (300) to the bicycle (5). At the top of FIG. 6 is the bicycle handlebars and at the bottom is the bicycle seat in dotted lines. Ordinarily connecting the bicycle handlebars and bicycle seat will be a lateral circular frame member (8). The shuttle rails of this invention (10, 200, 300) will be secured around the bicycle frame by means of bolts, nuts, and, where necessary, load spreader plates. It will be appreciated by one of skill in the art that any member of technologies including various closure and attachment means could be used to accomplish the goal of fixedly, but removably, attaching the shuttle rails (10, 200, 300) required for use of this invention. The description that follows is simply a description of one of the means that could be utilized. It is believed this means works well, uses off-the-shelf components, is secure, and is inexpensive. But other means could certainly be used, especially in specialized applications where weight or cost are of paramount concern. Moreover, when the invention is to be made a permanent part of a bicycle designed from scratch, the rails themselves could be made part of the structure of the bicycle, which could lead to a total redesign of the bicycle frame. Here, the right shuttle rail (10) and the left pedal shuttle rail (200) have lengthwise slots cut in their sides for receipt of bolts (201) and (11). The heads of the bolts will slide into their slots (not shown) where they can easily adjust for vertical motion. This allows the bicycle drive mechanism (1) to readily mount on differently designed bicycle frames and to different positions on a particular frame. When the two rails are in appropriate alignment the two bolts (201) and (11) can be screwed into a tightening nut (202) from each side, which allows the two rails (10) and (200) to be tightened into place against the lateral frame member (8) of the bicycle (5). It may be appropriate to use load spreaders or to keep the rails from bending or deforming the lateral frame member (8). On the side of the left pedal shuttle rail (200) is a pulley (710) used for the connecting element (750) and the pulley (713) on the right shuttle rail (10), as shown in FIG. 4. The left pedal shuttle rail (200) and the left shuttle rail (300) are connected by a piece that mounts the upper rail sprocket (304). The left shuttle rail (300) has slots cut lengthwise for receipt of bolt (301). There is a matching bolt (302) (not shown) on the underside of the lateral frame member (8). The bolts (301) and (302) are connected by a load spreader (303). Nut (313) goes over bolt (301) until it tightens against the load spreader (303) to hold the left rail (300) into place against the frame member (8). A similar nut (not shown) tightens the bolt (302) (not shown) into place. The pulleys (709) and (706) are seen in place respectively on the right shuttle rail (10) and the left rail (300). These pulleys are seen more clearly in FIG. 3B where the connecting element (700) coordinates movement of the right pedal shuttle (15) and the left shuttle (600), as seen in FIG. 3B. It will be readily appreciated by one of skill in the art that mounting the device to a bicycle (5) is no more complicated than connecting a few bolts with appropriate nuts and load spreaders in place around the frame of the bicycle. It will be readily appreciated that other bolts can be fixed around other frame members of the bicycle (5) to complete the mounting. For brevity, no drawing showing the remaining parts of the mounting apparatus will be presented. Referring to FIG. 1, the standard sprockets and gear mechanism used to allow gear changes on a bicycle remain unchanged. They are ordinarily mounted on an axle (7) to which the standard pedal crank arrangement is affixed. To attach the current invention to a bicycle will require replacing the standard axle or adding an extension. A somewhat longer axle (7) will go through opening in the frame of the bicycle replacing the standard axle. The new axle (7) extends somewhat further on the left of the bicycle as shown in FIG. 2. In FIG. 2, a left drive sprocket (20) is mounted on the new axle (7). The left drive sprocket (20) is mounted so when it rotates it causes a rotation of the axle (7). This rotation is transmitted to the standard sprocket and gear drive mechanism on the right side of the bicycle. The rotation of the left drive sprocket (20) is powered by the first driving element (101), which is driven by the power sprocket (105). The rotation of the power sprocket (105) follows. the rotation of the lower rail sprocket (305) because both are mounted on the power axle (705). Therefore, to complete the attachment of this invention to an existing bicycle, simply requires removing the axle on which the pedal are ordinarily mounted and replacing it with a similar, but somewhat longer axle (7), and mounting on that axle (7) a left drive sprocket (20) so that it can be connected by the first driving element (101) to the power sprocket (105). It will be readily appreciated by one of skill in the art that similar expedients could be employed to mount the drive mechanism (1) to other devices that use a pedal, crank, and sprocket drive mechanism, such as paddle boats or the like. The use of a second driving element (102) with parallel portions as it rotates around sprockets. The shuttle using clutch element (550) to engage and move the second driving element (102) converts the linear motion of the pedal shuttles into a rotary motion on the sprockets. This rotary motion can be easily used to replace the rotary motion created by the circular pedal, crank, and sprocket motion of a conventional mechanism whether employed for bicycles, paddle boats, pumps, or whatever.

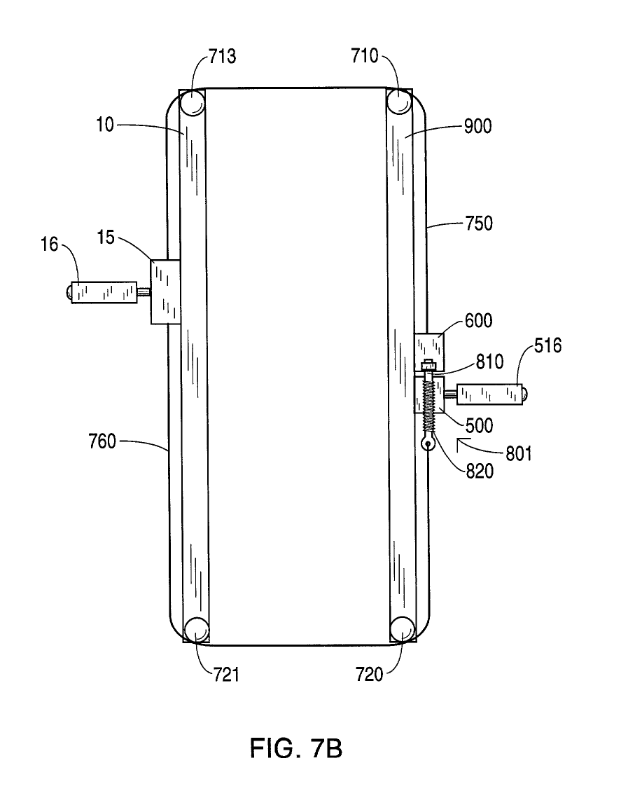

FIGS. 7A and 7B show an alternative embodiment of the current invention. It shows approximately the same equipment that is shown in FIGS. 3A, 3B, 4A, and 4B for the embodiment shown and described for those figures. FIG. 7A shows an alternative embodiment where the left pedal shuttle (500) is mounted on a double shuttle rail (900). Mounted above the left pedal shuttle (500) is the left shuttle (600). This is in contrast to what is shown in FIG. 3A where the left pedal shuttle (500) and the left shuttle (600) are mounted approximately side-by-side. As before, in FIG. 3A, there is a second driving element (102) passing around a lower rail sprocket (305) mounted on a power axle (705). The left pedal (516) is shown in dotted lines. A connecting element (760) connect one end of the mounting device (801) passing over pulleys (720) and (730) where a connecting element (760) connects to the bottom of the right pedal shuttle (15) (not shown in FIG. 7A). The mounting device (801) is similar to the mounting device (800) shown in FIGS. 4A and 4B in that both employ a rigid rod (810) and a spring (820) to allow independent motion of the right pedal shuttle (15) and the left pedal shuttle (500). As part of the mounting device (801), a rigid rod (810) passes through a protruding piece bore (18) on a protruding piece (17) on the left shuttle (600) and on the left pedal shuttle (500). The rigid rod (810) terminates in a bolt head which prevents the rigid rod (810) from downward motion relative to the left shuttle (600) when the bolt head butts up against the protruding piece (17) on the left shuttle (600). A spring (820) is mounted so that it exerts a pressure to keep the bolt head fixed against the left shuttle (600). Springs (820) mount over the rigid rods (810) below the protruding piece (17) on left pedal shuttle (500) and is restrained at the lower end of rigid rod (810) by spring stop (821). As with the mounting device (801), the spring stop (821) may be adjusted to vary the pressure of the spring (820) hence to vary the upward force exerted by the spring (820) on left pedal shuttle (500) against the bottom of protruding piece (17) on left pedal shuttle (500). This upward force keeps the left pedal shuttle (500) and the left shuttle (600) close if not touching. In this position, the spring (820) is mostly decompressed, thus prepared to allow the elasticity needed to desynchronize the left and right pedal shuttles (500) and (16) during the change in the direction of leg movement. Connecting elements (750) are attached to each side of the top of the left shuttle (600). When the right pedal shuttle (15) (seen in FIG. 7B) is pushed down by a user's feet, it necessarily pulls the connecting element (750) downwardly. This motion is transmitted and redirected by pulleys (not shown in FIG. 7A) to exert an upward pull on the left shuttle (600). When the left pedal shuttle (600) is pulled upwardly, the clutch element (550) grips the second driving element (102) and pulls it in an upwardly direction rotating the lower rail sprocket (305) in a counter-clockwise direction. Here, the clutch element (550) is shown as a sprocket fixed in the left shuttle (600). The sprocket will be disposed to rotate freely counter-clockwise, but to oppose rotation in a clockwise direction. This permits the second driving element (102) to freely move in a downward direction, but to be fixed into place when the left shuttle (600) is moving in the upward direction. This imparts the counter-clockwise motion to the lower rail sprocket (305). As the right pedal shuttle (15) is pressed downward by a user's foot, the left shuttle (600) is pulled upward by the connecting element (750). This upward force is transferred directly to the rigid rod (810) by the left shuttle (600), which means the tension that is established by a user in the connecting elements (750) and (760) remain the same even though the left pedal (516) and the right pedal (16) are moving independently of each other. It can be readily appreciated that, even though the left shuttle (600) remains stationary or may even be moving upwardly, the left pedal shuttle (500) can move downwardly within the limits of the length of the rigid rod (810) and of the spring (820) and spring stop (821). When the left pedal shuttle (500) moves downwardly, the clutch element (550) is constrained to grip the driving element (102) and force it downwardly, hence, causing a counterclockwise rotation of the lower rail sprocket (305). Thus, the left pedal shuttle (500) can be moving downwardly and the left shuttle (600) can be moving upwardly at the same time providing a double impetus to second driving element (102) around the lower rail sprocket (305) allowing a desynchronized pedaling motion.

FIG. 7B shows, from the front of a bicycle, the connection of the right pedal shuttle (15) to the left shuttle (600) and the left pedal shuttle (500). Omitted from FIG. 7B are the pulley and connecting elements on the back of the right pedal shuttle (15) and the left shuttle (600). As in the earlier embodiment, the right pedal shuffle (15) is mounted on the right shuttle rail (10) and uses a pedal (16) for the foot of the user. However, here there is no mounting element (800) on the right pedal shuttle (15). Rather, the two connecting elements (750 and 760) are connected respectively to the top and bottom of the right pedal shuttle (15). Ordinarily, the connecting elements (750) and (760) are flexible or coated wire and they will be connected to the respective shuttles (15, 600) with a tensioning screw or some other device that will allow a user to adjust the amount of tension in the connecting elements (750) and (760). As before, they pass over pulleys (713, 710, 721, 720) to redirect the force respectively exerted by the user. It will be understood that there are matching pulleys on the back of the right shuttle rail (10) and double shuttle rail (900). In FIG. 7B, the device is seen from the perspective of a viewer standing at the front of the bicycle. Therefore, from the viewer's perspective in FIG. 7B, the right shuttle rail (10) is on the viewer's left and the right pedal shuttle (15) is on the viewer's left. On the viewer's right is the double shuttle rail (900). The connecting element (750) having been redirected by the pulleys (713) and (710) connects downwardly to the left shuttle (600). Therefore, when a user pushes downwardly on the pedal (16), the right shuttle (15) moves downwardly on the right rail (10) pulling the connecting element (750) downwardly. This direction is redirected by the pulleys (713) and (710) to exert an upward force on the left shuttle (600). The mounting element (801) and, more specifically, the rigid rod (810) in the mounting element (801) is pulled upwardly as the left shuttle (600) is pulled upwardly by the connecting element (750). The clutch element (550) mounted on the left shuttle (600) begins to pull upwardly on the second driving element (102) (not seen in FIG. 7B). As the rigid rod (810) of the mounting element (801) is pulled upwardly along with the left shuttle (600), the spring (820) begins to exert an upward force on the left pedal shuttle (500). The connecting element (760) which is connected to the bottom of the rigid rod (810) is pulled upwardly matching the motion of the right pedal shuttle (15), the motion having been redirected by the pulleys (720 and 721). The matching pulleys on the other side of the right rail (10) and the double shuttle rail (900) are not shown in FIG. 7B.

As with the embodiment seen in FIGS. 3A, 3B, 4A, and 4B, the embodiment seen in FIGS. 7A and 7B allows for desynchronized pedaling. The position of the pedals may be easily adjusted by lengthening or shortening the connecting elements (750) and (760). As the right leg nears the end of the right power stroke, a user need not wait to begin the power stroke with the left leg. One may push down on the left pedal (516) causing a downward motion of the left pedal shuttle (500). The clutch element (550) will grip the second driving element (102) exerting a downward force on the second driving element (102) even while the left shuttle (600) is still moving upwardly and also exerting a force on the second driving element (102). As the spring (820) compresses fully, the user will stop the power stroke with the right leg on the right pedal (16). Once the pressure from the right leg is stopped, the spring (820) will begin to decompress pulling the left shuttle (600) toward the left pedal shuttle (500) while the left pedal shuttle (500) is still being pushed downwardly by a user using the left pedal (516). Unlike a standard bicycle, there is no lag as a user transfers the power stroke from one leg to the other. Here, because of the mounting device (801) and the spring (820) and because two clutch elements (550) work independently to grip the second driving element (102), a user may learn to begin a power stroke with one leg before the power stroke with the other leg is finished. During this overlapping period, the power strokes from both legs are transferred to the second driving element (102) then to the lower rail sprocket (305) and the driving torque is effectively doubled providing for a smooth transition, and no loss, or in fact, an increase of, power during the transition from using one leg to using the other leg to power the motion of a bicycle. Moreover, within the bounds of the lengths of the rigid rod (810) and of the compressive power of the spring (820) a user, under unusual circumstances, could simultaneously pump both pedals (16 and 516) to obtain short bursts of increased power. It is anticipated in most circumstances there will be a smooth transition from one leg to the other to provide the power stroke for the bicycle, but with the advantage of no lag of power during the transition. However, under some circumstances a user could apply a continuous power stroke with one leg while simultaneously applying short power strokes with the other leg within the limits provided by the length of the rigid rod (810) and of the compressive spring (820).

The two embodiments of this invention illustrated in FIGS. 3A and 3B, 4A and 4B, and 7A and 7B are not the only possible embodiments. The key factor in this invention is allowing one pedal to apply a power stroke simultaneously with the other pedal applying the power stroke. This is accomplished by use of the second driving element (102), which is simultaneously “pushed” and “pulled” by the respective left shuttle (600) and left pedal shuttle (500). The right pedal shuttle (15) and the left pedal shuttle (500) are elastically connected to synchronize their movement, but the elastic connection also allows their movement to be desynchronized within the limits of the elastic connection. Here, the elastic connection is provided by the spring (820) and the rigid rod (810) of the connecting mechanism (800) or connecting mechanism (801). FIGS. 4A and 4B illustrate the elastic connection between the right pedal shuttle (15) and the left pedal shuttle (500) when the left pedal shuttle (500) is mounted on the left pedal shuttle rail (200). By way of illustration of an alternative construction for the bicycle drive mechanism (1) (shown in FIGS. 4A and 4B) would be simply to connect the right pedal shuttle (15) to the left pedal shuttle (500) using elastic or power ropes of the type that is commonly called a “bungie cord.” The power rope would replace the connecting elements (750,760) and the connecting mechanism (800). For the embodiment of the drive mechanism (1) shown in FIGS. 7A and 7B, one of the connecting elements (760) would be a power rope that connects to the bottom of right pedal shuttle (15) and left pedal shuttle (500). The mounting device (801) would no longer be required. One connecting element (750) would be changed to a power rope and connect directly to the pedal shuttles (15) and (500). The other connecting element (750) would be unchanged—that is, made of flexible inelastic material connected to the right pedal shuttle (15) and left shuttle (600). The other connecting element (760) would still be made of a flexible inelastic material and connect first to the right pedal shuttle (15), then through pulley connect directly to the left shuttle (600), bypassing the no longer required connecting mechanism (801). The use of a power rope to replace the mounting device (800 or 801) would have limited application ordinarily where the use would be light or sporadic or perhaps for a children's bicycle. It is believed under heavy use the power rope would wear out too quickly to be practical. However, advances in materials which could provide for a durable power rope elastic connection between the right pedal shuttle (15) and the left pedal shuttle (500) which then could serve as a substitute to the connecting mechanism (800) or (801). Moreover, the elastic connection between the left pedal shuttle (500) and the right pedal shuttle (15) should be elastic enough to allow the clutch element (550) to engage and to allow two inches of motion of one pedal independent of the motion of another pedal. As shown in FIGS. 4A and 4B, the limits of the motion allowed for the pedals are the lengths of the connecting mechanisms (800) between the point of attachment of the connecting element (750) and spring stop (821) for both pedal shuttles. It is anticipated that the connecting mechanism (800) or (801) would easily disassemble to allow replacement of the spring (820) as required. Moreover, it is believed that some users would prefer a spring (820) that is easily compressed where others would prefer a heavier spring that is more difficult to compress. The spring (820) could be offered in different gauges, hence, different degrees of compressibility. The energy that is expended in compressing the spring during desynchronized pedaling is not lost but is stored by the spring. It is returned to the user in that the user must do less than in an ordinary bicycle to bring the leg back to a cocked position to begin the downward stroke again. At first glance, it might appears that it is a loss of energy when compressing the spring but, in truth, this energy is transferred through the spring to the second driving element (102) or to help the user return the user's leg to the appropriate position to begin a second power stroke using that same leg.

It will be generally understood by one of skill in the art that the methods and materials regarding the embodiments described above may be departed therefrom without affecting the overall functioning and essence of the invention disclosed in his application. The above descriptions are by way of illustration and not of limitation. The limitations are contained only in the claims which follow.

I claim:

1. A drive mechanism to allow a user to make desynchronized, continuous power pedaling to move a sprocket in a rotary motion for a device comprising:
(a) a first pedal shuttle mounted for reciprocal motion in a first rail guide;
(b) a second pedal shuttle mounted for reciprocal motion in a second rail guide;
(c) means for elastically connecting said first pedal shuttle and said second pedal shuttle whereby said first pedal shuttle and said second pedal shuttle may move in desynchronized motion within said elastically connecting means' limits.
(d) a drive element;
(e) a first means for gripping said drive element and forcing said drive element to move when said first pedal shuttle is pushed away from a user's torso;
(f) a second means for gripping said drive element and forcing said drive element to move when said second pedal shuttle is pushed away from a user's torso;
(g) means for mounting said first rail guide, said second rail guide, and said drive element to a device;
(h) means for transmitting said movement of said drive element to move a sprocket in a rotary motion.

2. A drive mechanism to allow a user to make desynchronized, continuous power pedaling to move a sprocket in a rotary motion for a device of claim 1 wherein said means for elastically connecting allows a predetermined amount of desynchronized motion sufficient to allow both said first means for gripping and said second means for gripping to grip said drive element simultaneously.

3. A drive mechanism to allow a user to make desynchronized, continuous power pedaling to move a sprocket in a rotary motion for a device of claim 2 wherein said predetermined amount is at least two inches of desynchronized motion between said first pedal shuttle and said second pedal shuttle.

4. A drive mechanism to allow a user to make desynchronized, continuous power pedaling to move a sprocket in a rotary motion for a device of claim 3 wherein said means for elastically connecting is at least one metal rod greater than two inches in length, a spring adjustably mounted along said rod, said spring and rod mounted through a bore in at least one of said first pedal shuttle or said second pedal shuttle and a flexible inelastic connector going from said rod mounted on said pedal shuttle to the other pedal shuttle, whereby said spring and rod allow desynchronized motion between said first pedal shuttle and said second pedal shuttle.

5. A drive mechanism to allow a user to make desynchronized, continuous power pedaling to move a sprocket in a rotary motion for a device of claim 3 wherein said means for elastically connecting is at least one stretchable power rope connecting said first pedal shuttle and said second pedal shuttle.

6. A drive mechanism to allow a user to make desynchronized, continuous power pedaling to move a sprocket in a rotary motion for a device of claim 4 wherein said drive element is a chain rotating around at least one first sprocket at a first end of said second rail guide and at least one second sprocket at a second end of said second rail guide opposite from said first end and first sprocket, a first lengthwise portion of said drive element going from said first sprocket to said second sprocket approximately parallel to a second lengthwise portion of said drive element going from said second sprocket to said first sprocket.

7. A drive mechanism to allow a user to make desynchronized, continuous power pedaling to move a sprocket in a rotary motion for a device of claim 5 wherein said drive element is a chain rotating around at least one first sprocket at a first end of said second rail guide and at least one second sprocket at a second end of said second rail guide opposite from said first end and first sprocket, a first lengthwise portion of said drive element going from said first sprocket to said second sprocket approximately parallel to a second lengthwise portion of said drive element going from said second sprocket to said first sprocket.

8. A drive mechanism to allow a user to make desynchronized, continuous power pedaling to move a sprocket in a rotary motion for a device of claim 6 wherein said flexible inelastic connector going from said rod mounted on said pedal shuttle to said first pedal shuttle or said second pedal shuttle is adjustable in length whereby said first pedal shuttle and said second pedal shuttle may be adjustably mounted at varying points on said first rail guide and said second rail guide, whereby a user may custom fit said replacement drive mechanism to a user's inseam measurement.

9. A drive mechanism to allow a user to make desynchronized, continuous power pedaling to move a sprocket in a rotary motion for a device of claim 8 wherein said first means for gripping said drive element is a clutch element mounted on a shuttle mounted to a third rail guide, said third rail guide adjacent and parallel to said second rail guide, said shuttle connected to said first pedal shuttle by flexible inelastic connecting elements whereby when said first pedal shuttle and said shuttle have synchronized reciprocal motion in respectively said first rail guide and said third rail guide.

10. A drive mechanism to allow a user to make desynchronized, continuous power pedaling to move a sprocket in a rotary motion for a device of claim 8 wherein said first means for gripping said drive element is a clutch element mounted on a shuttle mounted on said second rail guide adjacent to and above said second pedal shuttle, said shuttle connected to said first pedal shuttle by flexible inelastic connecting elements whereby said first pedal shuttle and said shuttle have synchronized reciprocal motion in said first rail guide and in said second rail guide.

11. A manually powered drive mechanism to allow a user to propel a bicycle having a bicycle frame, at least two wheels, and a gear and sprocket drive train, said mechanism comprising:
(a) a first pedal shuttle mounted for reciprocating motion in a first rail guide;
(b) a second pedal shuttle mounted for reciprocating motion in a second rail guide;
(c) said first rail guide and said second rail guide incorporated as part of said bicycle frame;
(d) an endless drive element mounted on one of said guide rails;
(e) a first and second clutch element mounted to grip said endless drive element; said first clutch element moving in response to motion of said first pedal shuttle away from a user's torso and gripping said drive element to transmit motion of said first pedal shuttle to said endless drive element; said second clutch element moving in response to motion away from a user's torso of said second pedal shuttle and gripping said drive element to transmit motion of said second pedal shuttle to said endless drive element;
(f) a transmission means connected to said drive element for transmitting motion from said drive element to said bicycle gear and sprocket drive train;
(g) means for elastically connecting said first pedal shuttle to said second pedal shuttle whereby said elastic connection of said first pedal shuttle and said second pedal shuttle allows first pedal shuttle and second pedal shuttle to move independently for at least a predetermined amount sufficient to allow both said first clutch element and said second clutch element to simultaneously grip said drive element.

12. A manually powered drive mechanism to allow a user to propel a bicycle having a bicycle frame, at least two wheels, and a gear and sprocket drive train of claim 11 wherein said means for elastically connecting said first pedal shuttle to said second pedal shuttle allows at least two inches of desynchronized movement between said first pedal shuttle and said second pedal shuttle.

13. A manually powered drive mechanism to allow a user to propel a bicycle having a bicycle frame, at least two wheels, and a gear and sprocket drive train of claim 12 wherein said means for elastically connecting is at least one metal rod greater than two inches in length, a spring mounted along said rod, said spring and rod mounted on a bore on a first particular pedal shuttle, said rod connected by at least one flexible inelastic element for reciprocal movement to a second particular pedal shuttle.

14. A manually powered drive mechanism to allow a user to propel a bicycle having a bicycle frame, at least two wheels, and a gear and sprocket drive train of claim 12 wherein said means for elastically connecting is at least one power rope connecting said first pedal shuttle and said second pedal shuttle.

15. A manually powered drive mechanism to allow a user to propel a bicycle having a bicycle frame, at least two wheels, and a gear and sprocket drive train of claim 13 wherein said first rail guide and said second rail guide are generally parallel to each other and are generally linear in shape.

16. A manually powered drive mechanism to allow a user to propel a bicycle having a bicycle frame, at least two wheels, and a gear and sprocket drive train of claim 15 wherein said at least one flexible inelastic element is adjustable in length, whereby said first pedal shuttle and said second pedal shuttle may be mounted adjacent to each other on said first rail guide and said second rail guide at different points along a length of said first rail guide and said second rail guide for adjustable fit to a user's inseam measurement.

17. A replacement drive mechanism for a bicycle to allow a user to make desynchronized, continuous power pedaling comprising:
(a) on a first side of a bicycle, a first rail guide with a first pedal shuttle mounted thereon;
(b) on a second side of a bicycle opposite from said first side of a bicycle, at least a second rail guide with a second pedal shuttle mounted thereon;
(c) an elastic connection connecting said first pedal shuttle and said second pedal shuttle to each other, said elastic connection allowing a predetermined amount of desynchronized movement between said first pedal shuttle and said second pedal shuttle to allow simultaneous power strokes from said first and second pedal shuttle;
(d) at least a first and second sprocket, said first sprocket mounted at a first end of said second rail guide and said second sprocket mounted at a second end of said second rail guide opposite from said first sprocket and said first end of said rail guide;
(e) an endless drive element oriented for movement around said first sprocket and said second sprocket, portions of said endless drive element extending from said first and second sprockets parallel to each other;
(f) a first means for gripping said drive element and forcing said drive element to move when said first pedal shuttle is pushed away from a user's torso and a second means for gripping said drive element and forcing said drive element to move when said second pedal shuttle is pushed away from a user's torso;
(g) a third sprocket connected to said second sprocket whereby rotation of said second sprocket caused by movement of said drive element is transmitted to said third sprocket;
(h) means for transmitting said rotational movement of said third sprocket to a bicycle gear and sprocket drive train.

18. A replacement drive mechanism for a bicycle to allow a user to make desynchronized, continuous power pedaling of claim 17 wherein said predetermined amount of desynchronized movement is at least two inches.

19. A replacement drive mechanism for a bicycle to allow a user to make desynchronized, continuous power pedaling of claim 18 wherein said elastic connection is at least one metal rod greater than two inches in length, a spring mounted along said rod, said spring and rod mounted through a bore in at least one of said first pedal shuttle or said second pedal shuttle including a flexible inelastic connector going from said rod mounted on one of said pedal shuttles to the other of said pedal shuttles whereby said spring and rod allow desynchronized motion between said first pedal shuttle and said second pedal shuttle.

20. A replacement drive mechanism for a bicycle to allow a user to make desynchronized, continuous power pedaling of claim 18 wherein said elastic connection is at least one power rope connecting said first pedal shuttle and said second pedal shuttle.

21. A replacement drive mechanism for a bicycle to allow a user to make desynchronized, continuous power pedaling of claim 19 wherein said flexible inelastic connector is adjustable in length, whereby said first pedal shuttle and said second pedal shuttle may be mounted adjacent to each other at adjustable predetermined points along said first rail guide and said second rail guide respectively, whereby a user may custom fit said first pedal shuttle and said second pedal shuttle to a user's inseam measurement.

22. A replacement drive mechanism for a bicycle to allow a user to make desynchronized, continuous power pedaling of claim 21 wherein said first means for gripping comprises a third rail guide, said third rail guide on said second side of a bicycle opposite said first side of a bicycle with a shuttle mounted thereon, said shuttle inelastically connected to said first pedal shuttle, whereby said first pedal shuttle and said shuttle have synchronized reciprocal movement in said first rail guide and in said third rail guide in a direction opposite from the motion of said first pedal shuttle when said first pedal shuttle is pushed away from a user's torso, said means for gripping said drive element grips said drive element on a side opposite of said drive element from the side of said drive element gripped by said second means for gripping.

23. A replacement drive mechanism for a bicycle to allow a user to make desynchronized, continuous power pedaling of claim 21 wherein said first means for gripping said drive element is a shuttle mounted on said second rail guide adjacent to and above said second pedal shuttle, said shuttle connected to said first pedal shuttle by flexible inelastic connecting means, whereby said first pedal shuttle and said shuttle have synchronized reciprocal movement in said first rail guide and in said second rail guide.
